(19) United States
(12) Patent Application Publication
(10) Pub. No.: US 2004/0118578 A1
(43) Pub. Date: Jun. 24, 2004

(54) Drill depth control device

(75) Inventor: Phillip O'Meley, Unandern New (AU)

Correspondence Address: James Earl Lowe Jr., 15417 W. National Ave. #300, New Berlin, WI, 53151, US

(73) Assignee: Joy MM Delaware, Inc.

(21) Appl. No.: 10/324,333

(22) Filed: Dec. 19, 2002

(51) Int. Cl. B23Q 5/00

(52) U.S. Cl. 173/152

(57) ABSTRACT

This invention provides a roof bolt installation apparatus including a drill stabilizing mechanism including a base having a cylindrical bore therein, and a stabilizing rod extendable from the base and slidably located in the bore. The rod has a distal end, and a drill stabilizing end plate is mounted on the rod distal end. The roof bolt installation apparatus also includes a drilling unit which is adapted to rotatably carry a drill, the drilling unit being slidably mounted on the drill stabilizing mechanism, and a mechanism for moving the drilling unit along the drill stabilizing mechanism. The roof bolt installation apparatus also includes a drill depth control device including a base, a top adapted to engage the mine roof, and at least two bars connected between the drill depth control base and the drill depth control top. The bars pass through openings in the drill stabilizing plate.

### BACKGROUND OF THE INVENTION

This invention relates to machines for drilling holes for roof bolts in mines, and more particularly, to such machines that insure that the roof bolt is secured in the mine roof at its proper depth.

Throughout this specification the words “roof bolt” and derivations of these words are taken to include other strata stabilisation articles and other similar named bolting articles such as rock bolts, anchor bolts, anchor tendons, tendons and any other similar articles which can be used for any purpose including drilling and bolting of ribs, floors, walls and faces of mines and any other location requiring strata stabilisation.

### SUMMARY OF THE INVENTION

The expression “roof bolt installation apparatus” when used in this specification and claims means an apparatus able to be predominantly used for roof bolting processes, but is also able to be used exclusively for drilling or coring purposes, without any actual installation of roof bolts. In which latter case the drilling unit, timber jack component and other components are simply used for drilling and or coring purposes alone.

Roof bolt installation apparatus also known as roof bolters, generally have a timber jack which is constructed from a structural member sliding in another structural member. The sliding mechanism is generally achieved by the attachment of similarly shaped angled rails to each structural member. These rails are attached along the longitudinal length of the structural members so that one structural member can extend from a compacted or retracted height to approximately 1.75 times the compacted or retracted height. Such a timber jack braces the roof bolter so that a drilling unit can first drill a surface and then install a roof bolt.

Mounted on a base portion of the timber jack is a feed unit which slides relative to the base portion. On the feed unit is mounted the drilling unit which slides thereon. The sliding action is also produced and guided by means of similarly constructed externally mounted rails on the structural members and on corresponding portions of the feed unit so that the feed unit can slide relative to the base of the timber jack.

It is an object of the invention to provide a roof bolt installation apparatus which ameliorates, at least in part, at least one of the disadvantages of the prior art.

This invention provides a roof bolt installation apparatus including a drill stabilizing means including a base having a cylindrical bore therein, and a stabilizing rod extendable from the base and slidably located in the bore. The rod has a distal end, and a drill stabilizing end plate is mounted on the rod distal end. The roof bolt installation apparatus also includes a drilling unit which is adapted to rotatably carry a drill, the drilling unit being slidably mounted on the drill stabilizing means, and means for moving the drilling unit along the drill stabilizing means. The roof bolt installation apparatus also includes a drill depth control device including a base, a top adapted to engage the mine roof, and at least two bars connected between the drill depth control base and the drill depth control top. The bars pass through openings in the drill stabilizing plate.

### BRIEF DESCRIPTION OF THE DRAWINGS

FIG. 1 is a roof bolt installation apparatus including a drill depth control device in accordance with this invention.

FIG. 2 is a side view of the roof bolt installation apparatus including a drill depth control device shown in FIG. 1 with the drill engaging a mine roof.

FIG. 3 is a side view of the roof bolt installation apparatus including a drill depth control device shown in FIG. 1 with the drill unit engaging the drill depth control device.

FIG. 4 is a side view of the roof bolt installation apparatus including a drill depth control device shown in FIG. 1 with the drill unit engaging the mine roof.

Before one embodiment of the invention is explained in detail, it is to be understood that the invention is not limited in its application to the details of the construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward” and “downward”, etc., are words of convenience and are not to be construed as limiting terms.

### DETAILED DESCRIPTION OF THE EMBODIMENTS

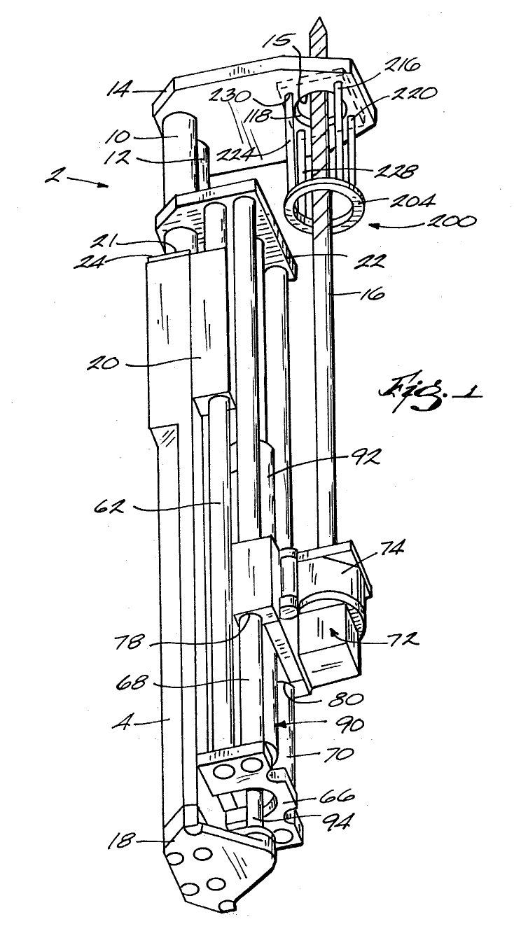

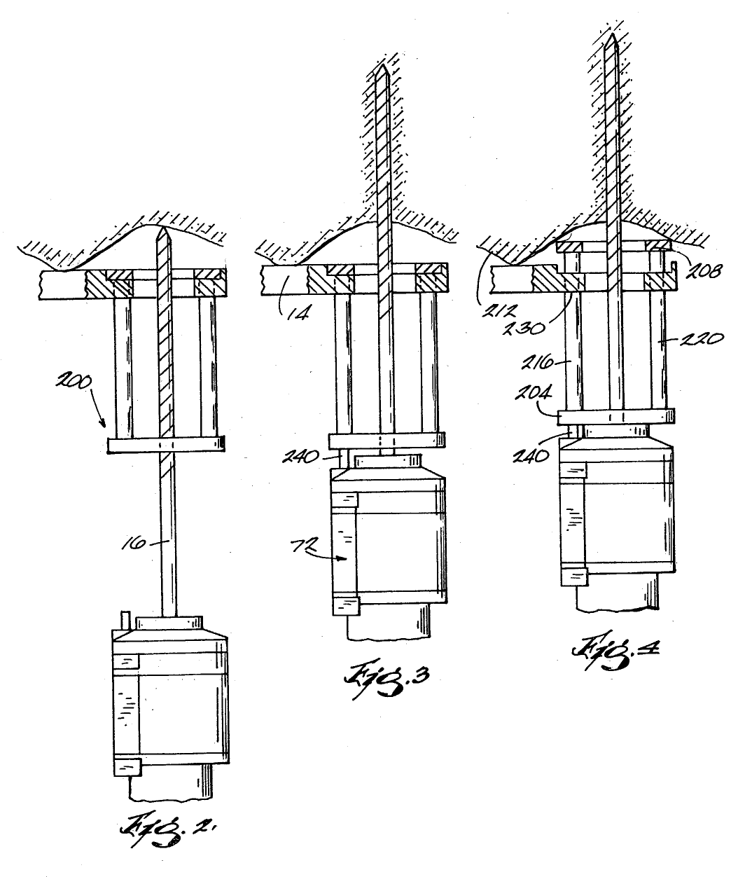

Illustrated in FIG. 1 is a roof bolt installation apparatus or roof bolter 2. The roof bolter has a first elongated member which acts as base and can also be called a feed carrier 4. The feed carrier 4 includes two elongated cylindrical bores (not shown). The bores each provide a sleeve for the cylindrical rods 10 and 12 to travel or slide in. The feed carrier 4, bores 6 and 8, rods 10 and 12, a rectangular end plate 14 and a ported T-shaped block 18 (which acts as a base member or foot for the roof bolter 2) together form an elongated timber jack 16, which can be used to brace the roof bolter 2 against opposite surfaces of a mine, tunnel or other structure. The T-shaped ported block 18 can be of any other appropriate shape.

The rods 10 and 12 are each connected (by any known means such as bolting or welding) to the end plate 14, to form a second member which is slidably mounted in the feed carrier 4. The slideable mounting of the rods 10 and 12 in the bores of the feed carrier 4 forms a first travel means or mechanism for the roof bolter 2.

The end plate 14 can be manufactured from a high tensile steel or other relatively rigid material. The end plate 14 acts as a guiding means for a drill rod or roof bolt passing through a bore 118, as is illustrated in FIG. 1.

If the end plate 14 is wholly manufactured from a relatively rigid material, in some situations where the roof bolter 2 is moving in a mine or the operator is not aware of the shape of the surface which end plate 14 will contact, the end plate 14, because it is relatively rigid can transfer damaging bending moments to the rods 10 and 12. As a solution to this problem the end plate 14 can be manufactured as a two piece unit (not shown). The first portion can be a relatively rigid portion to which the rods 10 and 12 attach. The second portion can be made of a relatively flexible material such as polyurethane or composite material or other appropriate material. The second portion can be attached to the first portion 14A by any known means such as bolting.

The rods 10 and 12 are of a length so that they will fit inside the bores 6 and 8, so as to fully retract the end plate 14. In the full retracted position, the end plate 14 sits adjacent a generally rectangular guide plate 22, which in turn sits adjacent the top 24 of the feed carrier 4.

The rods 10 and 12 are of circular cross section and are manufactured from high tensile steel, with a hard chrome finish.

Near to the top 24 of the feed carrier 4 is formed or secured two generally rectangular elongated slide blocks 20. The slide blocks 20 have through them longitudinal bores (not shown) which perform the function of sleeves. The slide block 20 carries in the bores 52, cylindrical feed frame rods 62 and 64 of a feed frame 60. The slide block 20 and the feed frame rods 62 (only one of which is shown) form a second travel means or mechanism of the roof bolter.

The feed frame rods 62 and 64 are each joined at one end to the guide plate 22 and at the other end are joined to end plate 66. The end plate 66 has a horse shoe shaped construction which might also be called U-shaped. Its U-shape is such that the bight of the U opens inward in a direction towards the feed carrier 4. The feed frame rods 62 and 64 are joined to the end plate 66 at the end of the end plate 66 which is closest to the feed carrier 4. The end plate 66 is U-shaped in the preferred embodiment as it is the shape which is considered to provide for ease of installation of a hydraulic cylinder 90. Another shape of end plate 66 could also suffice, such as a rectangular plate which has a hole or aperture in it, so that piston rod 92 can pass through it, which also provides a shoulder against which outer stage cylinder rod 94 abuts.

The guide plate 22 has rods 10 and 12 running through two appropriately sized apertures in the guide plate 22. Once the timber jack 16 is at least partially extended, the rods 10 and 12 will extend beyond the end 24 whereby the rods 10 and 12 act as a guide for the guide plate 22 to travel along. The end plate 66, rods 62 and 64, guide plate 22 and end plate 66 form the first part of the feed frame 60. This slidably interconnected arrangement of the feed frame 60 and rods 12 and 10 results in the feed frame 60 being guided and supported at all times, by four rods, which results in a very stable and rigid travel mechanism for a drilling unit 72, which may give it a relatively high level of accuracy

The second part of the feed frame 60 is made up of cylindrical rods 68 and 70 which are also connected at their respective ends to both guide plate 22 and end plate 66. At the end plate 66, the rods 68 and 70 are connected near to the ends of the legs of the U of the U-shaped end plate 66.

Slidably mounted on the rods 68 and 70 is a drilling unit 72. By the arrangement of these components, the feed frame 60 acts as a carriage means to carry the drilling unit 72. The drilling unit 72 includes a hydraulic motor 74 having a hexagonal drive 76, into which can be fitted the hexagonal end of a drill rod or a hexagonal nut on the end of a roof bolt. When placed in the hexagonal drive 76, a drill rod or roof bolt can be rotated to either drill a hole in a rock surface or alternatively rotate the roof bolt so as to mix resin placed in the hole and thus ultimately secure the bolt and tighten the nut to provide an anchor mechanism.

Alternatively, the drilling unit 72 could be a percussive type of drilling unit which drills only by cyclic or repetitive percussive forces. It could also be a rotational and percussive drilling unit which can be controlled to produce either percussive or rotational drilling or both. The drilling unit 72 does not need to be used just to install roof bolts. They could be used just to drill holes or take cores from walls, floors, faces, and ribs of mines or of any surface requiring strata stabilisation. The third and final part of the feed frame 60 is made up of an anchor plate (not shown) and an outer stage cylinder rod 94 of a hydraulic cylinder (not shown).

The drilling unit 72 has bores 78 and 80 through its housing in its left and right hand ends, which act as sleeves. The drilling unit 72, via the bores 78 and 80, is slidably mounted on the rods 68 and 70 of feed frame 60. The rods 68 and 70 and bores 78 and 80 of drilling unit 72 together form a third travel means or mechanism.

The rods 62, 64, 68 and 70 are manufactured in a similar manner to those of rods 10 and 12. These rods are also manufactured from high tensile steel which are given a hard chrome finish.

The hydraulic cylinder has an inner stage cylinder rod 92 and an outer stage cylinder rod 94. The inner stage cylinder rod 92 is secured at its lowest end to the ported block 18. The outer stage cylinder rod 94 is secured at its respective ends to the end plate 66 and guide plate 22. The outer body 96, because of the support given to it by the outer stage cylinder rod 94 is thus also positioned in the feed frame 60.

At the bottom end and on either side of the outer body 96 are pulleys 98 (only one of which is shown). At the top end and on either side of the outer body 96 are pulleys 102 (only one of which is shown). The drilling unit 72 is connected to the ends of chains (not shown). The chains pass over pulleys 102 and 104 and are secured at their ends to the anchor plate, which is installed in the feed frame 60. More details of the motive portion of the roof bolter can be found by reference to Neilson et al. U.S. Pat. No. 6,105,684.

This invention provides a roof bolt installation apparatus including a drill stabilizing means including a base having a cylindrical bore therein, and a stabilizing rod extendable from the base and slidably located in the bore. The rod has a distal end, and a drill stabilizing end plate is mounted on the rod distal end. The roof bolt installation apparatus also includes a drilling unit which is adapted to rotatably carry a drill, the drilling unit being slidably mounted on the drill stabilizing means, and means for moving the drilling unit along the drill stabilizing means. The roof bolt installation apparatus also includes a drill depth control device including a base, a top adapted to engage the mine roof, and at least two bars connected between the drill depth control base and the drill depth control top. The bars pass through openings in the drill stabilizing plate.

In one embodiment, the extendable rod end includes a guiding means for a drill rod placed in the drilling unit.

Mine roofs are often irregular. Because of the nature of the mining process, the mine roof is not flat, but has recesses and an irregular contour. Sometimes, a portion of the mine roof will fall. Other times, the mine cutting process results in chunks of the roof being removed. All of this causes the mine roof to have a very irregular shape. Present mine roof bolting machines have a face plate which bears against the mine roof. The faceplate will engage the first portion of the mine roof that it comes in contact with. This portion of the mine roof, however, may not be where the roof bolt hole is being drilled. As a result, several inches or more of the desired drill hole will not be drilled. This results in the mine roof bolt not being properly secured within the mine roof.

The roof bolt installation apparatus further includes a drill depth control. The control device includes at least two bars which extend between a top adapted to engage the mine roof and the base. The base whose is configured to sit on top of and be engaged by the drilling unit. Since most drilling units have a circular upper housing the base of the drill control is circular in this environment. In other embodiments, the base can have other shapes. In the preferred embodiment, four bars that are spaced apart are extending between the top and bottom of the drill depth control device. At least two of the bars, and in the preferred embodiment, all 4 of the bars pass-through the drill stabilizing end plate. Located within the drill stabilizing end plate are openings extending through the plate within the opening are bushings. The bushings facilitate easy movement of the depth control device through the openings in the drill stabilizing and plate.

In the preferred embodiment, the top is square. In other embodiments other shapes can be used. The top is sized so as to permit a roof anchor plate, designed to engage the mine roof. The roof bolt plate can pass through the opening in the top of the drilled depth control device. In other embodiments, a smaller top can be used, and the roof bolt plate can sit on top of the drill depth control device. One of the primary advantages of the invention is that the top is smaller than the drill stabilizing end plate. This permits the top of the drill depth control device to actually engage the true roof. This is despite the presence of depressions in the mine roof, or other irregularities in the mine roof.

In operation, as the drilling unit moves up the roof bolt installation apparatus it comes into engagement with the base of the drill depth control device. This pushes the drill depth control device up to where it eventually engages the mine roof. When this happens, the base of the drill depth control device comes into contact with a pilot valve on the top of the drill unit. The pilot valve is designed so that when it is engaged in a conventional way by contacting the drill stabilizing end plate, the drill unit can no longer continue moving up the roof bolt installation apparatus, but instead will now retract down the device. In this invention, the drilling unit pilot valve engages the base of the drill depth control device it does not meet with sufficient resistance to open, however. Once the drill depth control device engages the mine roof however, then the pilot valve will open, causing the drill unit to move back down the roof bolt insulation apparatus.

The foregoing describes some embodiments of the present invention and modifications by those skilled in the art can be made thereto without departing from the scope of the present invention.

1. A roof bolt installation apparatus including
a drill stabilizing means including a base having a cylindrical bore therein and a stabilizing rod extendable from said base and slidably located in said bore, said rod having a distal end,
a drill stabilizing end plate mounted on said rod distal end,
a drilling unit which is adapted to rotatably carry a drill, said drilling unit being slidably mounted on said drill stabilizing means,
means for moving said drilling unit along said drill stabilizing means, and
a drill depth control device including
a base
a top adapted to engage the mine roof
at least two bar connected between the drill depth control base and the drill depth control top, said bars passing through openings in said drill stabilizing plate.

2. A roof bolt installation apparatus according to claim 1 wherein said drill stabilizing means extendable rod has an end which can engage a surface through which a drill rod can extend.

3. A roof bolt installation apparatus according to claim 2 wherein said extendable rod end provides a guiding means for a drill rod placed in said drilling unit.
